(19) United States
(12) Patent Application Publication
(10) Pub. No.: US 2025/0274677 A1
(43) Pub. Date: Aug. 28, 2025

(54) IMAGE NOISE REDUCTION USING MODULATION AND DEMODULATION – MODULATION TECHNIQUES

(71) Applicant: Anduril Industries, Inc., Costa Mesa, CA (US)

(72) Inventors: Michael Joseph Tomaino Iannucci, Brookline, MA (US); Charles Jesse Barbon, Medford, MA (US); Joshua Kyle Byington, Harvard, MA (US); Daniel Robert Dell'Anno, Boston, MA (US); Joshua Joseph Brown, Newton, MA (US); Brian Thomas Appleton, Jr., Somerville, MA (US); Joseph Bari, Concord, MA (US); Matthew Gregory Brown, Arlington, MA (US); Michael W. Kelly, Cambridge, MA (US)

(21) Appl. No.: 18/585,214

(22) Filed: Feb. 23, 2024

(51) Int. Cl. H04N 25/60; G02B 7/08; G02B 7/36; H04N 23/55; H04N 25/20

(52) U.S. Cl. CPC H04N 25/60; G02B 7/08; G02B 7/36; H04N 25/20; H04N 23/55

(57) ABSTRACT

A system, method and device for filtering noise from image data is disclosed. The method includes: (a) obtaining an input optical signal input to an optical system, (b) modulating the input optical signal to obtain a modulated image signal, wherein the input optical signal is modulated based at least in part on manipulating a point spread function (PSF) of the optical system, (c) providing the modulated image signal to a read-out integrated circuit (ROIC), and (d) obtaining a filtered image signal from the ROIC, wherein the ROIC filtered the modulated image signal to remove at least part of excess noise.

### BACKGROUND OF THE INVENTION

Infrared (IR) signals play a crucial role in various applications, including communication, imaging, sensing, and security systems. However, the effective utilization of IR signals can be impeded by the problems of interference, noise, and limitations in the existing filtering mechanisms. The conventional filtering techniques often fall short in providing signal clarity and can be susceptible to environmental factors, leading to non-optimal performance in real-world scenarios.

### BRIEF DESCRIPTION OF THE DRAWINGS

Various embodiments of the invention are disclosed in the following detailed description and the accompanying drawings.

FIG. 1 is a block diagram of a system for filtering noise from an input optical signal according to various embodiments.

FIG. 2 is a block diagram of a system for filtering noise from an input optical signal according to various embodiments.

FIG. 3 is a diagram of a system for filtering noise from an input optical signal according to various embodiments.

FIG. 4 is a diagram of an example of Random Telegraph Signal (RTS) noise of optical system represented in the frequency domain.

FIG. 5A is a diagram of an input optical signal to an optical system according to various embodiments.

FIG. 5B is a graph of a modulated image signal according to various embodiments.

FIG. 6 is a graph comparing noise in image data for an unmodulated optical input signal and a modulated image signal according to various embodiments.

FIG. 7A is an example of an integration period for collecting image data according to related art.

FIG. 7B is an example of an integration period for demodulating image data according to various embodiments.

FIG. 7C is an example of an integration period for demodulating image data according to various embodiments.

FIGS. 8A and 8B illustrate an optical lens system for modulating an input optical signal according to various embodiments.

FIGS. 9A and 9B illustrate configurations of an optical lens system through which the optical lens system is cycled during a modulating of an input optical signal according to various embodiments.

FIG. 10A is an image of reference object to be characterized by an optical system.

FIGS. 10B and 10C are an image of the reference object characterized by conventional techniques.

FIG. 10D is an image of the reference object characterized by an optical system according to various embodiments.

FIG. 11 illustrates a cam-driven optical lens system for modulating an input optical signal according to various embodiments.

FIG. 12 illustrates a transition period for modulating an input optical system according to a cam-driven optical lens system according to various embodiments.

FIGS. 13A and 13B illustrate examples of a phase delay wheel for an optical lens system according to various embodiments.

FIGS. 14A and 14B illustrate examples of using a set of lenses in an optical lens system to module an input optical signal system according to various embodiments.

FIG. 15 illustrates an acousto-optical modulator for modulating an input optical signal according to various embodiments.

FIG. 16 illustrates an electro-optical modulator for modulating an input optical signal according to various embodiments.

FIG. 17 illustrates a chopper for modulating an input optical signal according to various embodiments.

FIG. 18 illustrates a cross-polarized system for modulating an input optical signal according to various embodiments.

FIG. 19 illustrates an electro-optical modulator for modulating an input optical signal according to various embodiments.

FIG. 20 illustrates a system for modulating an input optical signal based on dithering a line of sight of an optical lens system according to various embodiments.

FIG. 21 is a flow diagram of a method for filtering noise from an input optical signal according to various embodiments.

FIG. 22 is a flow diagram of a method for filtering noise from an input optical signal according to various embodiments.

FIG. 23 is a flow diagram of a method for filtering noise from an input optical signal according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Related art high-performance imaging systems (e.g., infrared imaging systems) often have several shortcomings, including excess noise and non-uniformity. The problems associated with excess noise and non-uniformity are further described below.

Related art imaging sensors (e.g., infrared detection sensors) can often exhibit excess noise. Excess noise corresponds to noise that is above the fundamental shot noise floor. The excess noise can be due to many different possible sources that are present in the image sensor or the electronics used to interface with the sensor. Often, the noise is “low frequency” noise. Low frequency noise may be 1/fⁿ noise (where f is frequency and n is typically a positive number), random telegraph noise (RTN), or random telegraph signals (RTS). It is desirable to reduce or completely remove excess noise from the image prior to display or digital processing of the image.

Various embodiments implement a technique to eliminate (or at least reduce) unwanted excess noise (e.g., noise arising from the imaging sensors, electronics, or stray light) from motion imaging data in real time. Additionally, various embodiments may simultaneously apply enhancing image processing algorithms. The techniques for eliminating unwanted noise can be implemented with a Computational Pixel Imager (CPI) device. A CPI device is a digital-pixel focal plane array (DFPA) with compute functions built into the pixel to perform digital signal processing and image processing operations prior to image readout. Alternatively, the techniques according to various embodiments may be implemented with various other types of imaging systems/sensors.

In the temporal/frequency domain, each pixel of an image sensor comprises an optical transducer that detects incoming photon signals (e.g., an input optical signal) and generates an electrical signal that is proportional to the temporally varying light intensity. In an N×N image sensor array, the array comprises N² pixels producing N² unique, time-varying electrical signals. The signals are individually sampled on the image sensor and digitized to capture and record the image content. In general, all the signals are sampled at the same point in time (or as close as possible) by averaging them over a pre-defined integration (or exposure) period.

In the spatial domain, the time-averaged signals are captured to record an electronic representation of the 2-dimensional scene. The captured image record is digitized for performing image processing/computer vision algorithms on the data to enhance the image for information extraction.

Typically, the image sensor module of a camera captures the temporally low-pass-filtered image and digitizes the pixel data to pass to a processor or computer to apply and execute image processing algorithms. However, CPI technology can implement temporal/frequency domain digital signal processing techniques at the pixel level and coordinate the data collection of the image sensor pixel array with mechanisms that temporally modulate or manipulate the optical scene information content (e.g., the image data).

Various embodiments can optimize the image collection to capture the desired information content while ignoring the unwanted aspects of the data (like excess noise). Various embodiments perform one or more the following substantially simultaneously and in real-time with collection of the input optical signal:
Modulation of the optical scene at a frequency that is higher than the knee frequency where the excess noise present in each pixel's transduced optical signal is equal to the fundamental shot noise. The transduced optical signal can be in the form of photocurrent from a photodiode array, or other types of read-outs from other circuits that enable electrical readouts of detected light from detectors such as microbolometers or charge coupled devices (CCDs). The modulation waveform can be sinusoidal or non-sinusoidal.
Demodulation of the signal in each pixel to recover the scene content. For example, the demodulation occurs inside each pixel within a read-out integrated circuit (ROIC).
Application of digital signal processing (DSP) filters to the pixel signals prior to demodulation. The system can tailor the filtering (to an extent) and, in contrast to conventional image sensors, is not limited to simple low-pass filtering. The system can use the CPI technology to configure the filtering.
Application of 2-D image non-uniformity compensation as part of the image collection process. A non-uniformity compensation algorithm may be applied as part of the demodulation process. In some embodiments, only the offset non-uniformity is compensated. In other embodiments, both the offset and gain non-uniformity are compensated.
Application of 2-D image processing filters as part of the image collection process. In some embodiments, optical aberrations imposed on the image light field are modulated before detection by the focal plane sensor. Various embodiments implement the modulation and per-pixel demodulation processes to apply spatial filtering to the resulting digital image. In some embodiments, the system (e.g., the modulation module) implements a filter similar to a traditional Difference of Gaussian (DoG) filter. The system can configure the properties of the DOG filter to obtain the desired image enhancement.
Application of 2-D spatial convolution filters as part of the image collection process. The system may shift the digital image north, south, east, and west on the CPI, in synchronization with the modulator, and appropriately weighting the exposure at each shift position, and may apply a linear 2-D convolutions filters to further enhance the digital image.
Application of a matched filter kernel as part of the image collection process. The system may implement a 2-D linear filter configured to maximize the SNR of an unresolved point target when convolved with the scene is applied in synchronization with the modulator.

System noise characteristics are referred to by different names depending on their properties. Shot noise is a fundamental physical limit of how well an imaging system can measure the information content in a scene. A shot noise limited imaging system has historically been considered the optimal performance that can be achieved, and therefore is the goal of most imagers. Imaging sensors often also exhibit degradation in performance due to excess noise, noise that is above the fundamental shot noise floor. The excess noise can be a current or voltage that is fluctuating in time in an unpredictable way on the focal plane or read out integrated circuit (ROIC). Excess noise can be due to many different possible sources in the image sensor, or the electronics used to interface with the sensor. For example, excess noise sources are present in the pixel sensor devices due to material and process defects. Unlike shot noise which exhibits broadband “white” spectral content, the fluctuations associated with excess noise often have strong frequency dependence, weighted towards the low frequency part of the spectrum. Often, the noise falls off with the inverse of frequency (1/f) or the inverse of frequency squared (1/f²) or in general 1/fⁿ, where n is a positive number. In practice, in many infrared imaging systems, low frequency noise with 1/f and 1/f² are significant and limit the system's performance, particularly at long integration or exposure times. In some cases, this low-frequency excess noise is called random telegraph noise (RTN) or random telegraph signal (RTS), and RTN and RTS are a common noise found in infrared imaging systems. Thus, for IR imaging systems reducing or removing 1/fⁿ noise from the image prior to display or digital processing of the image would be beneficial.

Related art high-performance imaging systems generally require a Non-Uniformity Correction (NUC) to generate clean imagery. A NUC compensates the image frames on a pixel-by-pixel basis to compensate for variations in offsets and gains across an individual focal plane. This pixel-by-pixel non-uniformity typically drifts over time, particularly the offset values. This temporal drift necessitates reapplication of the NUC repeatedly during operation. In other words, a system cannot always compensate for the variations simply by measuring the variation during a factory calibration.

Various related art techniques implement methods for calculating and applying a NUC in real-time that have been researched and implemented in the past. Determining the method of NUC can often be a critical technical for any new imaging system being designed. Various embodiments inherently address this problem of pixel-by-pixel variations, thereby eliminating the need for a traditional NUC.

Various embodiments address the growing demand for reliable and high-performance infrared signal filtering, especially in fields such as telecommunications, surveillance, and industrial automation. To address challenges of the related art filtering techniques, various embodiments leverage advanced optical input/collection systems, signal processing algorithms, or a combination thereof, to achieve superior infrared filtering.

A system, method, and device for filtering noise from image data is disclosed. The method includes: (a) obtaining an input optical signal input to an optical system, (b) modulating the input optical signal to obtain a modulated image signal, wherein the input optical signal is modulated based at least in part on manipulating a point spread function (PSF) of the optical system, (c) providing the modulated image signal to a read-out integrated circuit (ROIC), and (d) obtaining a filtered image signal from the ROIC, wherein the ROIC filters the modulated image signal to remove at least part of excess noise in the image signal.

A system, method and device for filtering noise from image data is disclosed. The method includes: (a) obtaining image data based at least in part on a modulated image signal, wherein the modulated image signal is obtained based on modulating an input infrared signal, (b) demodulating the image data to obtain a filtered image signal in which at least part of 1/fⁿ noise is filtered from the image data, and (c) providing the filtered image signal.

Various embodiments provide a system, method and device for filtering noise from image data is disclosed. The method includes: (a) obtaining an input optical signal input to an optical system, (b) modulating the input optical signal to obtain a modulated image signal, wherein the input optical signal is modulated according to a predefined frequency, (c) providing the modulated image signal to a read-out integrated circuit (ROIC), (d) demodulating, by the ROIC, the modulated image signal to obtain a filtered image signal in which at least part of 1/fⁿ noise is filtered from the image data, wherein the modulated image signal is demodulated based at least in part on a synchronizer signal, and (e) providing the filtered image signal.

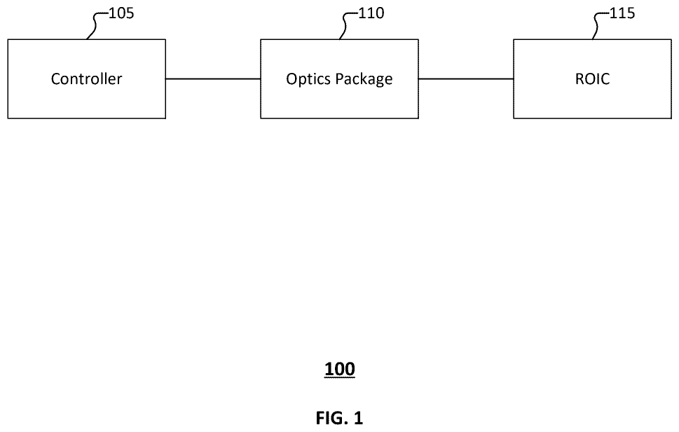

FIG. 1 is a block diagram of a system for filtering noise from an input optical signal according to various embodiments. System 100 is configured to remove 1/fⁿ noise in image data for a captured incident light of a scene. In the example shown, system 100 comprises controller 105, optics package 110, and a synchronized filtering system (e.g., a real-time synchronized circuit such as ROIC 115). For the discussion below, the system is discussed with regard to ROIC 115, however a person practiced in the art could easily understand how to extend the below to any appropriate synchronized filtering system. In some embodiments, system 100 uses controller 105 to cause modulation in an input optical signal, such as an infrared light of a scene being captured/measured. The input optical signal may be modulated based on controlling the optics package 110 to modulate incident light, such as by using a modulation module.

In some embodiments, the system modulates the input optical signal based at least in part on one or more of (i) manipulating a point spread function (PSF) of the optical system of optics package 110, (ii) modulating a line of sight of the image signal prior to being incident on ROIC 115, and/or (iii) modulating an intensity of the image signal as incident on ROIC 115.

Controller 105 controls system 100 (e.g., optics package 110) to modulate the input optical signal according to a predefined frequency. In some embodiments, the predefined frequency is higher than the noise (e.g., the excess noise present in each pixel photocurrent signal of the focal plane detector). For example, the predefined frequency is higher than the—noise knee frequency or any other frequency that enables the reduction of noise desired for the system.

In some embodiments, optics package 110 comprises a modulator, one or more lenses, and a focal plane array. The modulated image signal is incident on the one or more lenses, which focus the modulated image signal on a focal plane array. The focal plane array is configured to detect the modulated image signal (e.g., to collect image data for the scene associated with the input optical signal).

The output from optics package 110 is provided to ROIC 115. ROIC 115 filters the RTS or excess noise from the modulated image signal. For example, system 100 provides image data detected by optics package 110 and provides the image data to ROIC 115, which processes the image data to obtain a filtered image signal. In some embodiments, ROIC 115 is configured to demodulate the image data. ROIC 115 may implement a demodulation at the same frequency as the modulation frequency used to modulate the input optical signal.

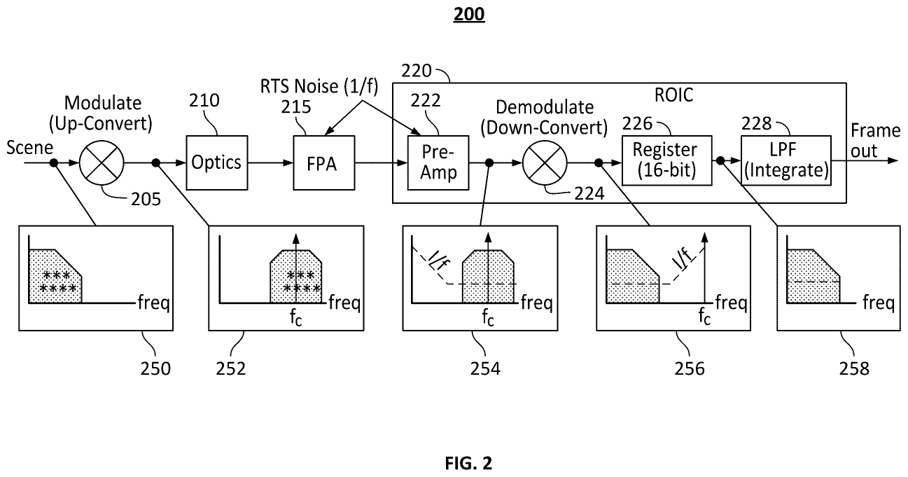

FIG. 2 is a block diagram of a system for filtering noise from an input optical signal according to various embodiments. In some embodiments, system 200 is configured to receive an input optical signal (e.g., infrared light for a scene) and filter excess noise, such as RTS or excess noise, to obtain a filtered image signal. In the example shown, system 200 comprises modulator 205, optics 210, detector 215, and ROIC 220.

As shown in FIG. 2, an input optical signal 250 capturing scene information is input to system 200. The input optical signal 250 is modulated using modulator 205 to obtain an upconverted signal such as modulated image signal 252. The modulated image signal 252 exits optics 210, detector 215 and amplifier 222. Detector 215 and amplifier 222 may introduce excess noise, such as RTS noise. Accordingly, noisy modulated image signal 254 may be obtained from amplifier 222. The noisy modulated image signal 254 is input to demodulator 224, which demodulates the noisy modulated image signal 254 to obtain a demodulated image signal 256. Demodulated image signal 256 is input to filter 228 to obtain a filtered image signal.

Modulator 205 is configured to modulate the input optical signal according to a particular frequency. The particular frequency used to modulate the input optical signal may be determined or determined substantially in real-time such as to account for drift or variation during operation.

System 200 uses modulator 205 to upconvert the static (DC) scene signal to a high frequency. In some embodiments, modulator 205 upconverts the scene to a frequency that is higher than the excess noise knee frequency. An example of how a scene might be modulated is by manipulating the point spread function (PSF) of the optical system (e.g., optics 210) thereby causing the image to go into and out of focus in rapid succession.

Optics 210 may comprise one or more lenses and/or mediums through which incident input optical signals are received and redirected to detector 215. For example, optics 210 is configured to focus the incident light to a focal plane (e.g., a focal plane of detector 215).

In some embodiments, modulator 205 and optics 210 are combined. For example, an optics package may be configured to comprise modulator 205 and optics 210. Modulator 205 may be configured to actuate optics 210 to thereby modulate the incident light. Examples of optics 210 includes (a) causing one or more lenses to move, (b) causing one or more lenses to be sequentially blocked and unblocked (e.g., using a chopper to physically block/unblock the light or by changing alignment of polarized lenses) to allow incident light to pass therethrough, (c) causing a medium through which the light passes to sequentially permit light to pass therethrough or prevent light from passing therethrough, (d) causing a path of the incident light to effectively lengthen (e.g., by sequentially changing, or increasing and decreasing, an index of refraction of the medium through which the light passes; or by sequentially increasing or decreasing the physical thickness of the medium/lens(es) through which the light passes), (e) causing one or more lenses to sequentially focus and stop focusing incident light on a focal plane, (f) causing one or more lenses to dither, etc. Various other techniques may be implemented to modulate the collected input optical signal.

Detector 215 detects the incident light redirected/focused by optics 210. Detector 215 may convert the optical signal to a digital signal, such as by detecting charges on a detector/sensor. For example, detector 215 comprises a plurality of image or light sensors. In some embodiments, detector 215 comprises a focal plane array (FPA). Detector 215 detects the image or spatial information for the modulated image signal (e.g., modulated image signal 252).

A FPA may be a two-dimensional array of detectors or sensors used in imaging devices such as cameras and infrared sensors. Each element in the array, often referred to as a pixel, is capable of detecting light or other electromagnetic radiation. The arrangement of these pixels enables detector 215 to capture an image or otherwise record spatial information (e.g., to capture the scene).

In optical imaging systems, the FPA is typically used to capture visible light. In the case of infrared imaging systems, FPAs can be designed to detect infrared radiation, enabling the visualization of heat patterns. FPAs are crucial components in various applications, including digital cameras, thermal imaging devices, and satellite sensors, allowing for the conversion of incoming light or radiation into electronic signals for image processing and analysis.

A read-out integrated circuit (ROIC) is a specialized electronic component designed to interface with and process signals from sensors, particularly in imaging devices. ROICs are commonly used in various applications such as infrared (IR) imaging, visible light imaging, and other sensor-based systems. The primary function of an ROIC is to convert the signals generated by the sensor into a readable and usable format. ROICs play an important role in imaging systems, especially in applications such as infrared imaging (thermal imaging) where specialized sensors are used to detect heat signatures. The integration of ROICs with sensors allows for the creation of effective and versatile imaging devices across various industries, including security, medical imaging, and defense. Examples of features or functions of an ROIC include:
Signal Readout: The primary function of an ROIC is to read out signals generated by an image sensor (e.g., detector 215) or another type of sensor. This involves the conversion of analog signals from the sensor into digital signals that can be further processed or transmitted.
Analog-to-Digital Conversion: ROICs often include built-in ADCs to convert the continuous analog signals from the sensor into discrete digital values. This digital representation allows for easier processing and manipulation of the data.
Signal Conditioning: ROICs may incorporate various signal conditioning techniques to enhance the quality of the sensor signals. This can include amplification, filtering, and other preprocessing steps to improve signal-to-noise ratios and overall performance. In various embodiments, signal conditioning includes processing for individual pixel elements, groups or subgroups of pixel elements, for all of the pixel elements of a detector, or any other appropriate set or subset of pixel elements for processing the detected signal from a sensor. In some embodiments, processing includes demodulation of modulated optical signal that is received by the sensor. In some embodiments, the demodulation is synchronized with the modulation of the optical signal that is received by the sensor. In some embodiments, the synchronization is achieved by providing a signal from a modulation mechanism or driving signal/circuit for modulation and the circuit/method for demodulation. In some embodiments, a phase adjustment or timing delay is used to adjust the synchronization signal from the modulation before it is used by the demodulation circuit/method.
Pixel Readout: In imaging applications, ROICs are designed to read out signals from individual pixels in an image sensor array. Each pixel corresponds to a specific location in the captured image, and the ROIC processes the signals from these pixels in a systematic manner.
Timing Control: ROICs often include timing control circuits to synchronize the readout process with the operation of the sensor. Precise timing is crucial for capturing accurate and synchronized data from the sensor array.
Digital Output: The processed signals can be output in digital form. This digital output can be further transmitted, stored, or processed by other components in the system.
Integration with Sensor Arrays: ROICs are designed to work seamlessly with different types of sensor arrays, including charge-coupled devices (CCDs), bolometers, complementary metal-oxide-semiconductor (CMOS) sensors, photodiode or barrier detector arrays, and other sensing technologies.
Low-Noise Operation: Given that sensor signals can be weak and susceptible to noise, ROICs are often engineered for low-noise operation to maintain signal integrity and improve the overall quality of the acquired data.
Power Efficiency: Many ROICs are designed to be power-efficient, especially in portable or battery-operated devices. Power efficiency is crucial for extending the operational life of the overall system.

ROIC 220 comprises amplifier 222, demodulator 224, register 226, and filter 228. In some embodiments, ROIC 220 further comprises one or more of a multiplexer, an ADC, timing and control circuitry, a digital signal processing (DSP) module(s), an output interface, biasing and reference circuits, power management modules, temperature compensation circuits, communication interfaces, test and calibration circuits. Each of the foregoing components are further described below.

Amplifier 222: one or more amplifiers are used to boost the weak analog signals generated by the pixels. This is important for maintaining signal integrity and improving the signal-to-noise ratio.

Demodulator 224: a demodulator is used to demodulate the modulated image signal. In some embodiments, demodulator 224 demodulates the modulated image signal at the same frequency used by modulator 205 to modulate the optical input signal.

Register 226: Register 226 may comprise one or more registers (e.g., a 16-bit register) that serve as a storage element for configuration settings, control parameters, and other data relevant to the operation of the ROIC. Examples of functions of register 226 include (a) storage of configuration settings that define how the ROIC operates; (b) storage of timing and control parameters that govern the sequencing of operations within the ROIC; (c) pixel selection within the pixel array (e.g., detector 215) for readout, including storage of parameters for determining an order in which pixel values are read out, a readout rate, etc.; (d) storage of analog signal processing parameters; (e) digital signal processing parameters and/or algorithms; (f) storage of calibration data; (e) interfacing with external devices or microcontrollers for obtaining an output from ROIC 220.

Filter 228: a filter is used for signal processing. For example, filter 228 is a low-pass filter having a primary purpose to allow low-frequency signals to pass through while attenuating or blocking higher-frequency components. In ROIC 220, filter 228 can be used to perform one or more of noise reduction, signal conditioning (e.g., signals obtained from the pixel array may comprise unwanted high-frequency components that can distort the overall signal), anti-aliasing, bandwidth limitation, improve the dynamic range, prevent interference, enhance the image quality, etc.

Multiplexer: System 200 may use a multiplexer for selecting and routing signals from individual pixels to subsequent stages for further processing. The multiplexer helps in sequentially reading out signals from each pixel.

ADC: System 200 may use an ADC to convert the analog signals from the amplifiers into digital values. The conversion of the analog signals to digital signals enables further digital processing and analysis of the signals.

Timing and Control Circuitry: ROIC 220 may include timing and control circuits to synchronize the readout process and manage the overall operation of the sensor. This ensures that signals are read out in a coordinated and systematic manner.

Digital Signal Processing (DSP): ROIC 220 may include DSP components for additional processing of the digital signals. This can include filtering, image enhancement, and other computational tasks.

Output Interface: ROIC 220 may include an output interface through which the processed signals can be transmitted to external components, such as a data processor or display unit. This output interface may include digital outputs, such as parallel or serial interfaces.

Biasing and Reference Circuits: ROIC 220 may include biasing and reference circuits to provide the necessary biasing voltages and reference signals to ensure proper operation of the pixel array, amplifiers, and other components.

Power Management: ROIC 220 may include circuits for power management to optimize power consumption. Power management is particularly important in portable or battery-operated devices.

Temperature Compensation Circuits: In some applications, temperature compensation circuits may be integrated into ROIC 220 to ensure the ROIC 220's stable performance under varying temperature conditions.

Communication Interfaces: ROIC may include communication interfaces for external control and configuration. This allows for communication with other components in the system or with a central control unit.

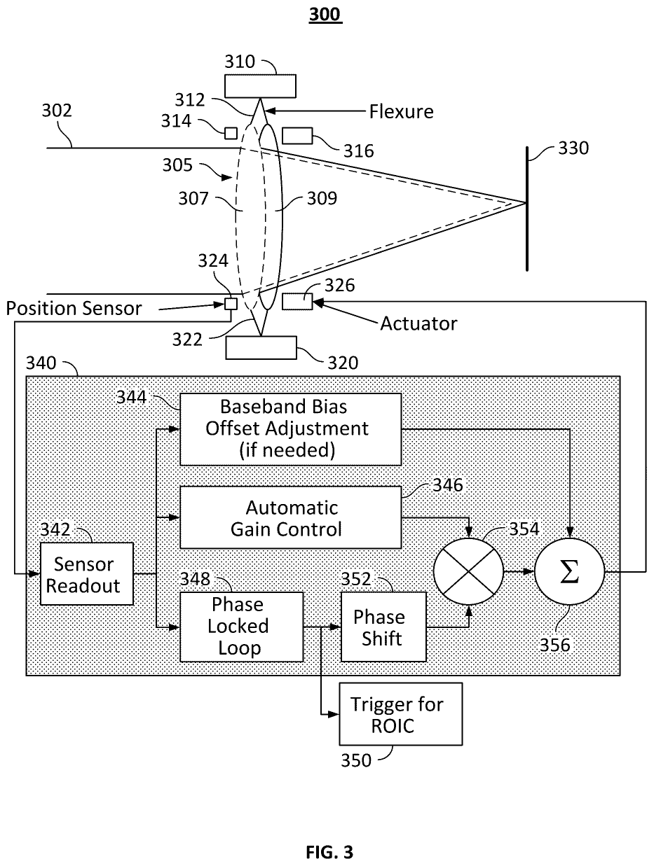

FIG. 3 is a diagram of a system for filtering noise from an input optical signal according to various embodiments. In some embodiments, system 300 comprises a system for modulation and control of modulation to implement some of the functions of controller 105 and optics package 110 of FIG. 1 and/or modulation 205 and optics 210 of FIG. 2. In the example shown, an input optical signal 302 to system 300 is modulated based on manipulating the PSF. A rapid focus/defocus modulation can be implemented by mounting an optical element 305 to a flexurized bezel and driving it using an actuator. The flexurized bezel can comprise a first bezel member 310 and a second bezel member 320, and optical element 305 is mounted to the first bezel member 310 via flexure 312, and optical element 305 is mounted to the second bezel member 320 via flexure 322. The optical element 305 is actuated to move relative to first bezel member 310 and second bezel member 320 via actuators 316 and 326 to cause optical element 305 to move between a first position 307 (e.g., an in-focus position) and a second position 309 (e.g., an out of focus position). The resulting modulated optical signal is incident on detector 330 (e.g., an FPA), which detects the modulated image signal, which may be passed to an ROIC (not shown) for processing and demodulation.

System 300 may further comprise position sensors 314 and 324 which are configured to detect a modulation position, such as position of the optical element 305 or another component from which the sensor data can indicate whether a relative position between optical element 305 and the flexurized bezel. Sensor data from position sensors 314 and 324 is collected by controller 340, which is implemented to keep optical element 305 moving at the predefined modulation frequency at a fixed amplitude. Controller 340 maintains optical element 305 movement via a phase-locked loop (PLL) 348 that picks up the predefined modulation frequency and generates a (phase adjusted) drive current to the actuators.

In some embodiments, controller 340 comprises a sensor readout module 342 that reads out the sensor data from sensors 314 and 324. The collected sensor data is then input to PLL 348, which picks up the sensor signal at the predefined modulation frequency. Additionally, the collected sensor data may be input to a baseband bias offset adjustment module 344 that determines an adjustment (e.g., an offset) for the baseband bias and/or an automatic gain control module 346.

According to various embodiments, the PLL signal output from 348 is output to an ROIC 350 which is configured to process the detected modulated image signal. In some embodiments, the PLL signal is a synchronizer signal that synchronizes a modulation frequency used for modulating the input optical signal and a demodulation frequency used to demodulate the modulated image signal. For example, ROIC 350 synchronizes the frequency at which the modulated image signal is demodulated with the modulation frequency used to modulate the input optical signal.

Controller 340 may further implement a phase shift module 352 that performs a phase shift on the phase locked loop signal. The output from the phase shift module is input to multiplier 354 at which it is multiplied with the output from the automatic gain control module 346. The output from multiplier 354 is input to accumulator 356 that accumulates the output from multiplier 354 with a baseband bias offset determined by baseband bias offset adjustment module 344.

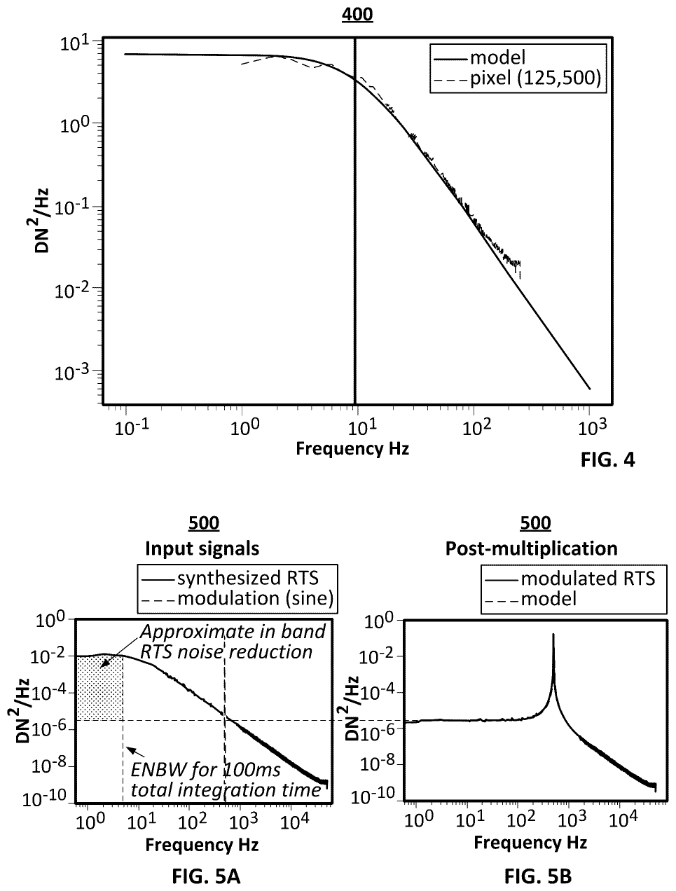

FIG. 4 is a diagram of an example of Random Telegraph Signal (RTS) or excess noise of an optical system represented in the frequency domain. Graph 400 illustrates an example of RTS or excess noise that may be introduced to an image signal by the detector (e.g., the FPA) and/or an amplifier. RTS noise can be modeled as a two-parameter random signal with characteristic time constants 11 and 12, which are the mean durations spent in the low and high states. The probability of being in a low or high state for some duration t is given by the exponential distribution:

$$P ( t ) = \frac{1}{τ} exp ( - t / τ ) .$$

In the frequency domain, the power spectral density of RTS noise exhibits a broad plateau at low frequencies, and a 1/f² roll-off at higher frequencies. The transition point between these two regions occurs at the characteristic frequency of the RTS, given by

$${f}_{c} = \frac{1}{2 π} ( \frac{1}{{τ}_{1}} + \frac{1}{{τ}_{2}} ) .$$

The power spectral density of RTS noise is represented by Equation (1).

$$S ( f ) = 4 {A}^{2} ( \frac{{τ}_{1} {τ}_{2}}{{( {τ}_{1} + {τ}_{2} )}^{2}} ) ( \frac{1 / T}{{( 2 π f )}^{2} + {( 1 / T )}^{2}} ) \qquad ( 1 )$$

In Equation (1), A is the amplitude of the RTS signal, and T=1/(2πf_{c}). Further, because the noise bandwidth set up by the imager integration time (Tᵢₙₜ) extends from zero frequency to ½Tᵢₙₜ (e.g., a low-pass filter), the plateau of high noise associated with RTS falls within the noise bandwidth of the imager.

Modulating RTS noise reduces the in-band (0 Hz to ½Tᵢₙₜ Hz) noise power by up-converting the RTS noise to a higher, out-of-band frequency. Referring back to FIG. 2, modulation of RTS noise occurs at the demodulator 224. At this stage, the scene signal (e.g., the modulated image signal) is demodulated (down-converted), but the noise is modulated (up-converted).

FIG. 5A is a diagram of an input optical signal to an optical system according to various embodiments. FIG. 5B is a graph of a modulated image signal according to various embodiments. FIGS. 5A and 5B show the power spectral density of RTS noise before and after the modulation operation. In the example shown, the modulation waveform is a pure tone, but other modulation waveforms, such as a square wave, produce comparable results. As shown, by multiplying (e.g., modulating) RTS noise and a sine wave, the majority of the RTS noise power is shifted to a higher frequency that falls far outside of the noise bandwidth. In this example, the in-band noise is reduced by a few orders of magnitude.

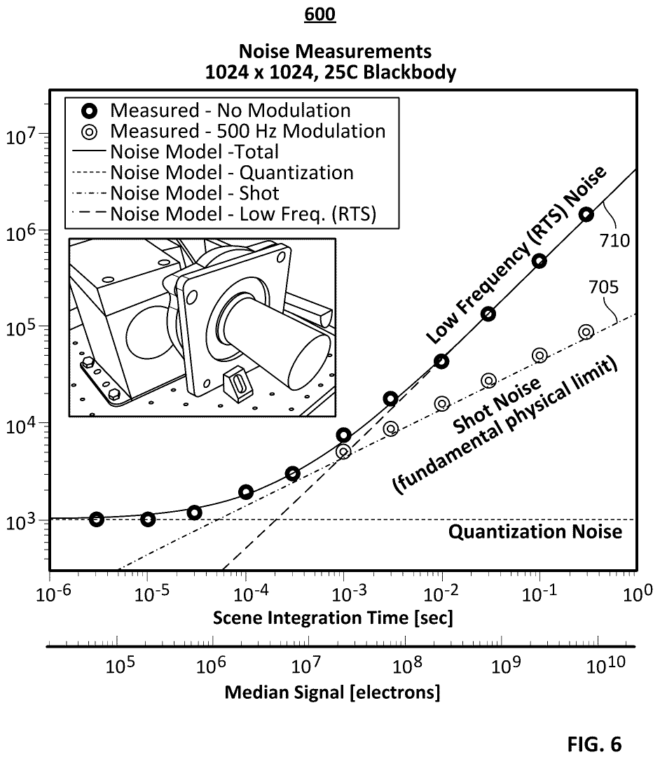

FIG. 6 is a graph comparing noise in image data for an unmodulated optical input signal and a modulated image signal according to various embodiments. In the example shown, graph 600 shows noise measurements made on a long-wave infrared camera (LWIR) imager in both traditional and modulated modes. As shown with result 605, selecting a modulation frequency in a shot-noise limited regime eliminates RTS noise or other noise for arbitrarily long integration times. The system thus mitigates the RTS noise or other noise, which results in improvements in signal to noise ratio (SNR) will continue to accrue with increasing integration time. In some embodiments, a total noise in the filtered image signal is very nearly equal to a fundamental noise limit. In some embodiments, a total noise in the filtered image signal is very nearly equal to a fundamental noise limit. In comparison, without the modulation technique as shown with result 610, SNR will reach a maximum at the integration time where low frequency noise starts to dominate and will not increase with integration time.

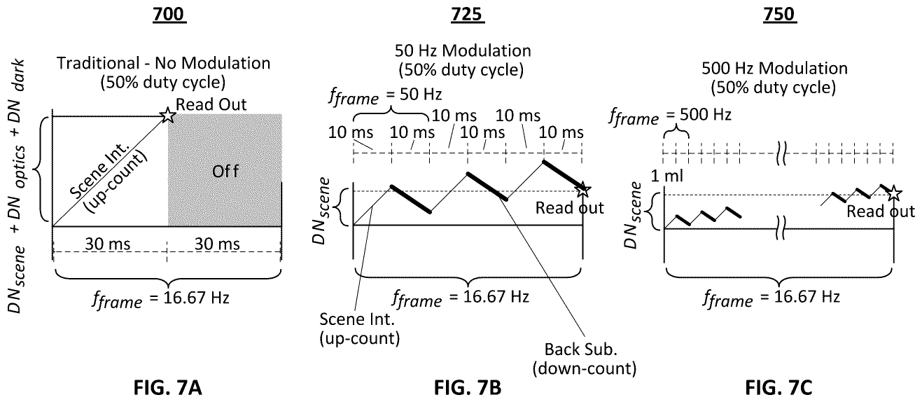

FIG. 7A is an example of an integration period for collecting image data according to related art. FIG. 7B is an example of an integration period for demodulating image data according to various embodiments. FIG. 7C is an example of an integration period for demodulating image data according to various embodiments.

Generally, to image a scene, the detector in each pixel of an imager is generating a transduced optical signal from the scene, from unwanted sources (such as optical emission from the lenses themselves in the case of infrared imaging) and dark current as a function of time. The dark current is typically determined by the temperature of the device (higher T often leads to higher dark current). The total current in each pixel is Iₜₒₜₐₗ=I_{scene}+I_{optics}+I_{dark}.

At the end of a given integration time, a digital number (DN) representing the amount of charge accumulated from all these currents is read out from each pixel. This is effectively the time integral of the total current equation above. This is represented on the y-axis in the plot on the left of FIG. 7A by DN_{readout}=DN_{scene}+DN_{optics}+DN_{dark}. These sources of current consume the available dynamic range of the imager, while the photocurrent associated with the scene is typically the only signal that is useful. The other components are excess signal.

In the example shown in FIG. 7A, frame 700 depicts the integration of a signal that has not been modulated using the techniques disclosed herein. Frame 700 includes a 50% duty cycle in which a first half of the frame (e.g., the first 30 ms) the system up-counts the signal detected/read-out from the detector. During the second half of the frame (e.g., the last 30 ms) the system reads-out the value of the scene that was integrated. As illustrated, the value read out comprises contributions from the scene, the optics, and dark noise. For example, the value read out comprises a sum of DN_{scene}+DN_{optics}+DN_{dark}. As shown in frames 725 and 750 for FIGS. 7B and 7C, the image signal can be demodulated to result in a signal that comprises contribution from the scene without contribution from the noise generated by the optics or the dark noise.

According to various embodiments, in a system that is square wave demodulated using a CPI ROIC, the charge counter is alternatively switched between accumulating charge, or “up counting”, and decumulating charge, or “down counting”. In some embodiments, the switching between up-counting and down-counting is triggered to occur synchronously with the scene modulation. For example, the system uses a synchronizer signal to synchronize the modulation and demodulation (e.g., the synchronizer signal can be based on sensor data capturing modulation of the optical element). In some embodiments, the electronics that controls the modulator generates an in-phase signal which is used to cue the ROIC to toggle between up/down counting. In some embodiments, a set phase can be manually or automatically set between the in-phase signal and the ROIC. The scene modulation effectively removes the photo current associated with the scene, leaving I_{optics}+I_{dark} to be subtracted during the down count cycle. Note that, by subtracting I_{optics}+I_{dark} during each demodulation cycle, the excess signal sources of DN_{optics}+DN_{dark} are removed from DN_{readout}, leaving only the scene information (e.g., the filtered image signal in which the excess noise is filtered from the modulated image signal), DN_{scene}. Accordingly, the useful dynamic range of the imager may be maximized.

This cyclical toggling between up and down counting can be repeated many times in each CPI pixel during each readout cycle. Therefore, the read-out cycle rate, or frame rate, need not be increased in order to accommodate the demodulation. This is depicted in frames 725 and 750 of FIGS. 7B and 7C, respectively. In some embodiments, the rate at which the demodulation occurs can also be altered without changing the frame rate, as can be seen in frames 725 and 750 of FIGS. 7B and 7C.

The system can implement the demodulation of a modulated image signal with various types of images. The examples shown in FIGS. 7B and 7C illustrate the demodulation technique applied to a modulated image signal using a CPI ROIC.

Frame 725 illustrates the demodulation of the modulated image signal using a 50 Hz modulation frequency. Using the 50 Hz modulation frequency, the system up-counts for the first 10 ms, and down-counts for the second 10 ms of the period defined by the 50 Hz modulation. The signal up-counted for the first 10 ms comprises contributions from the scene, the optics, and dark noise. In contrast, the signal down-counted for the second 10 ms comprises contributions from the optics and the dark noise (e.g., the value for the signal detected at the detector is not counted). Thus, assuming that the optics and dark noise are generally uniform across the first 10 ms and the second 10 ms, the down-counting during the latter 10 ms strips out the optics and dark noise so that over the 20 ms cycle the only contribution in the integrated signal corresponds to the scene.

Frame 750 illustrates the demodulation of the modulated image signal using a 500 Hz modulation frequency. When using a 500 Hz modulation frequency, the system sequentially up-counts (e.g., accumulates the signal for the scene, the optics noise, and the dark noise) for 1 ms and down-counts (e.g., strips out the optics and dark noise) for 1 ms and repeats this over the entire frame.

According to various embodiments, modulation by Point Source Function (PSF) manipulation comprises taking the difference between a focused and defocused image whereby the defocused image spoils scene spatial content. The resulting difference image is often (but not always) a spatially filtered representation of the scene. Modulation by manipulating the PSF results in an image that approximates the use of a standard difference of Gaussians (DoG) filter. A DoG filter is a common computer vision and image processing technique to enhance static greyscale images. It is achieved by subtracting one blurred version of an original grayscale image from another, less blurred version of the same original.

The blurred images are traditionally obtained by convolving the original grayscale image with Gaussian kernels having differing standard deviations. Blurring an image using a Gaussian kernel suppresses only high-frequency spatial information. In the modulation technique of manipulating the PSF, rather than blurring static images by convolving the static images with a Gaussian blur kernel, the system blurs the scene in real time by defocusing an optical element (e.g., an element in the camera lens assembly). Because the excess noise (e.g., the typically low frequency noise) and excess signal is present in both the in-focus and defocused images, it is subtracted out from the resulting difference image. For example, the excess noise is subtracted out during the down-counting phase of the demodulation phase. According to various embodiments, the system eliminates excess noise from infrared image data where low-frequency noise can be problematic.

According to various embodiments, the spatial frequency content of the scene (e.g., the scene represented by the input optical signal) can be controlled to some extent by the amount of defocus that is applied to the scene. As an example, the modulation by PSF manipulation technique can be used to enhance edges and point targets making them easier to detect and track. In some embodiments, the image difference is computed using the in-pixel computational capability of CPI sensors, prior to readout.

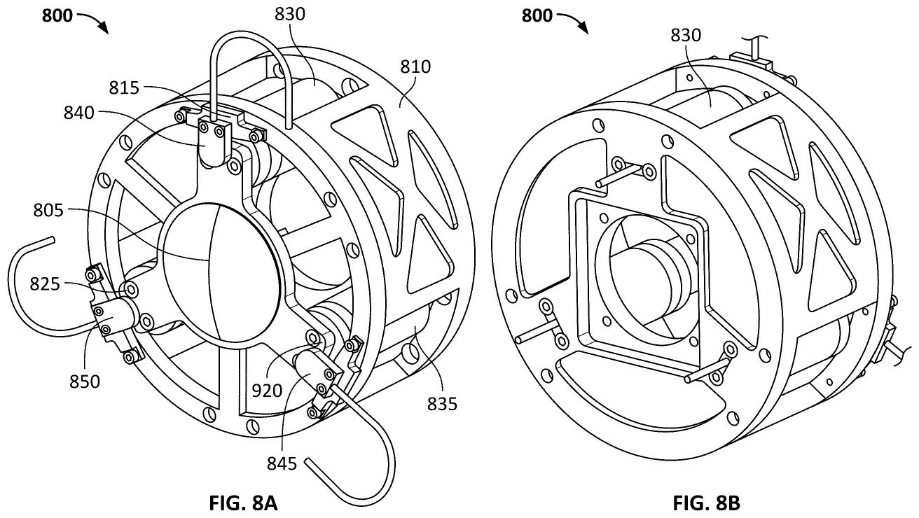

FIGS. 8A and 8B illustrate an optical lens system for modulating an input optical signal according to various embodiments. In the example shown, the system comprises an optical lens system 800 and uses an optical element (e.g., one or more lenses or lens assembly) mounted to a flexurized bezel to modulate the input optical signal by manipulating the PSF. Optical lens system 800 comprises a three-flexure bezel that is driven by one or more actuators according to a predefined modulation frequency. In some embodiments, the one or more actuators comprise voice coil actuators that can be driven to achieve high-rate axial lens modulation.

As illustrated, optical lens system 800 comprises optical element 805 mounted to bezel 810. Optical element 805 is mounted to bezel 810 via a plurality of flexures, such as flexure 815, flexure 820, and flexure 825. The system (e.g., a controller) drives actuation of one or more actuators to change a relative position of the optical element 805 with respect to a focal plane array or other detector. For example, the one or more actuators actuate to axially displace the optical element 805 relative to the bezel 810 or the focal plane array. The actuators used to cause the optical element 805 to be axially displaced may comprise a plurality of voice coils, such as voice coils 830 and 835 which are voice coils with linear bearings.

Various embodiments implement one or more sensors to detect the modulation. In the example shown, optical lens system 800 comprises one or more capacitive sensors, such as capacitive sensor encoders 840, 845, and 850. A capacitive sensor can be mounted on the system to measure displacement amplitude or information indicative of a relative position of the optical element 805. In some embodiments, the sensor data obtained by the one or more sensors is provided to a controller which can use the sensor data to control actuation of the one or more actuators. Additionally, the controller can generate/provide a synchronizer signal which is used by a demodulator (e.g., an ROIC that controls the demodulator) to synchronize the demodulation of the modulated image signal with the modulation of the input optical signal.

In some embodiments, optical element 805 comprises one or more lenses. In some embodiments, optical element 805 is a 50 mm aspheric germanium lens. Various other types of lenses may be implemented.

In some embodiments, the flexure dimensions of flexure 815, flexure 820, and flexure 825 can be adjusted in order to achieve the desired modulation frequency.

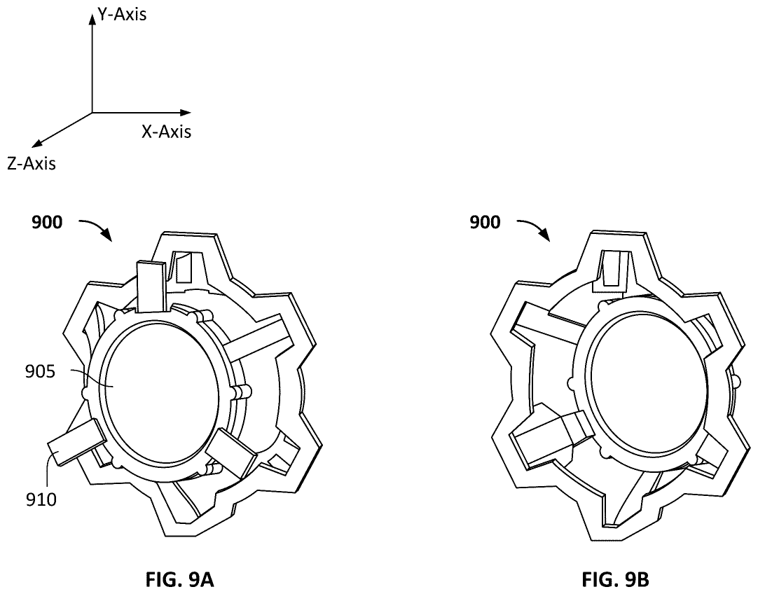

FIGS. 9A and 9B illustrate configurations of an optical lens system through which the optical lens system is cycled during a modulating of an input optical signal according to various embodiments. In the example shown, optical lens system 900 is illustrated in different configurations based on the actuation of the optical element. In some embodiments, optical lens system 900 corresponds to optical lens system 800 of FIGS. 8A and 8B.

As illustrated, optical lens system 900 comprises optical lens 905 that is mounted to bezel 910 by flexures. FIG. 9A illustrates optical lens 905 axially displaced in the positive upwards direction in the z-axis. FIG. 9Billustrates optical lens 905 axially displaced in the negative downward direction in the z-axis. The system actuates to cause optical lens 905 to sequentially transition from the configurations illustrated in FIGS. 9A and 9Bto modulate the input optical image signal.

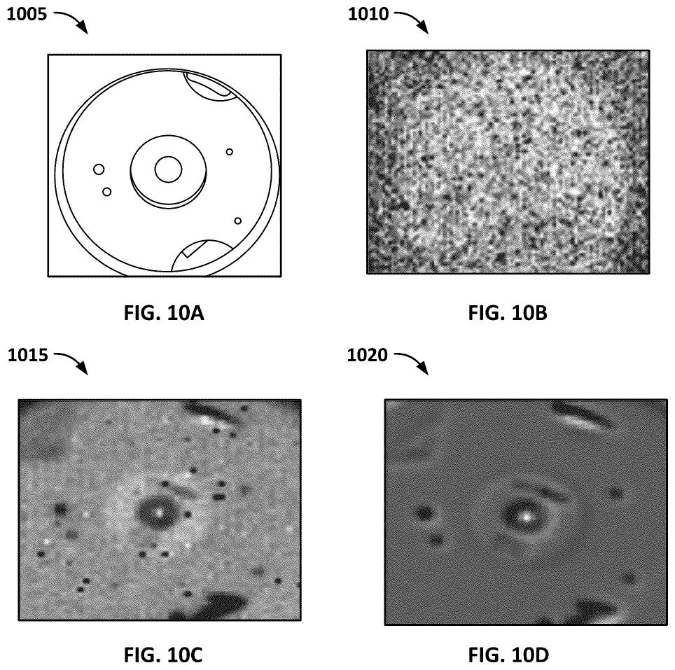

FIG. 10A is an image of reference object to be characterized by an optical system. In the example shown, image 1105 is a reference image that is to be imaged by an optical system. A pinhole is in the center of the scene with an IR source behind it.

FIGS. 10B and 10C are an image of the reference object characterized by conventional techniques. In the example shown, images 1010 and 1015 are images obtained by conventional imagery.

FIG. 10D is an image of the reference object characterized by an optical system according to various embodiments. Image 1020 is obtained based on the modulation techniques described herein. For example, the system modulates the input optical signal and correspondingly demodulates the modulated image signal such as to remove the excess noise. Image 1020 can be obtained without a NUC applied, and as shown in FIG. 10D, the modulated imagery is much cleaner and less noisy than images 1010 and 1015 obtained by conventional imagery techniques.

Various other techniques can be implemented to manipulate the PSF in connection with modulating the input optical signal. For example, in some implementations, the system uses other techniques for axially displacing an optical element relative to a detector (e.g., to cause the scene to be sequentially toggled between an in-focus configuration and an out of focus configuration. Examples of other techniques are further described below.

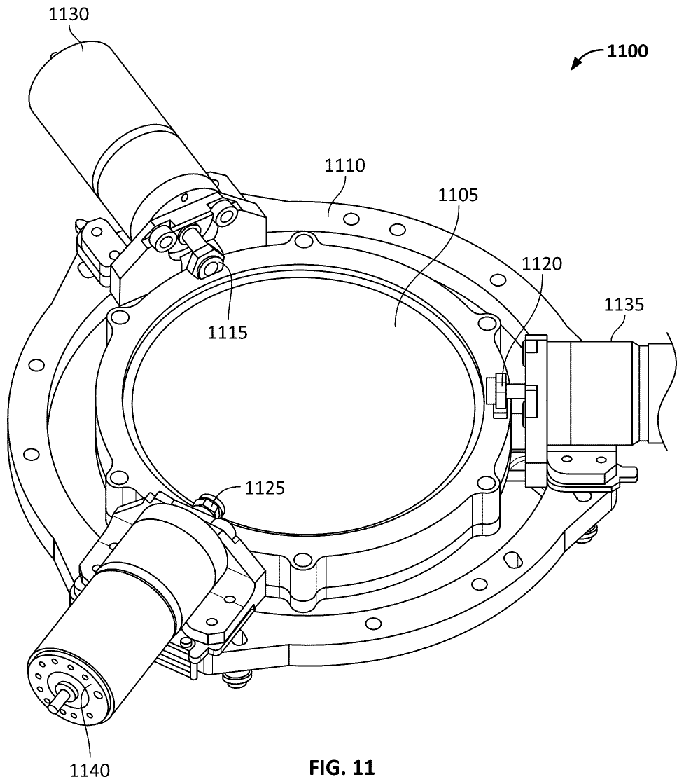

FIG. 11 illustrates a cam-driven optical lens system for modulating an input optical signal according to various embodiments. In some embodiments, the system manipulates the PSF by axially displacing an optical element. System 1100 implements one or more cam shafts with variable radii that are used to push a lens in and out of focus. In the example shown, system 1100 comprises optical element 1105 mounted to bezel 1110.

In some embodiments, optical element 1105 is biased to an out of focus position and system 1100 drives the one or more cams (e.g., cam 1115, cam 1120, and cam 1125) to push optical element 1105 to the in-focus configuration using motor 1130, motor 1135, and motor 1140. For example, the one or more cams is/are configured with variable radii and comprises a first portion(s) having a first radius and a second portion(s) having a second radius. An example of such a configuration is illustrated in FIG. 11B. The one or more cams may be further configured to have a set of transition periods between the first portion and the second portion. The transition period may be 10 degrees or other predefined period. Various other lengths may be implemented for the transition period(s).

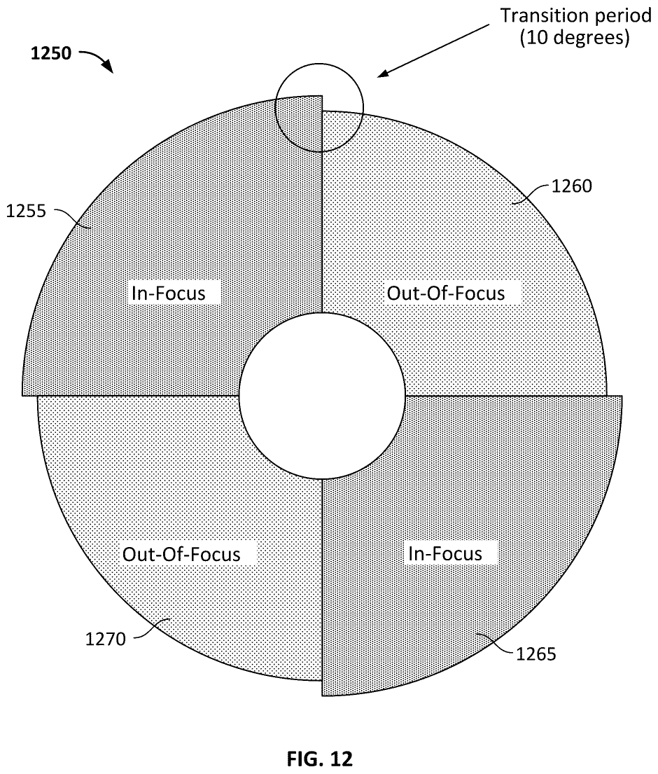

FIG. 12 illustrates a transition period for modulating an input optical system according to a cam-driven optical lens system according to various embodiments. In the example shown, a front view of the cam shaft along the axis around which the cam rotates is provided. As illustrated, cam 1250 comprises a set of first portions 1255 and 1265 having a first radius, and a set of second portions 1260 and 1270 having a second radius. Cam 1250 may be implemented for cam 1215, cam 1220, and/or 1225 of FIG. 12.

The first radius is larger than the second radius. Accordingly, when the cam engages the optical element 1205 the cam 1250 pushes the optical element 1205 to axially displace the optical element 1205 relative to the detector (e.g., the focal plane array). The optical element 1205 may be axially displaced by a distance based on a difference between the first radius and the second radius. As cam 1250 is further rotated/driven, the first portion with the first radius disengages the optical element 1205 and the second portion with the second radius engages the optical element 1205 (or the biasing of the optical element 1205 causes optical element 1205 to engage the second portion).

In some embodiments, the cams and optical element assembly is designed such that a mechanical pre-load is placed against the cams 1215, 1220, and 1225 so that the axial position of the optical element 1205 (e.g., a lens) follows the cam radii as cams 1215, 1220, and 1225 are rotated. In some embodiments, an optical lens (e.g., a lens of optical element 1205) is mounted to a bezel by a set of flexures, and the bezel is preloaded with a spring to keep the optical lens motion in contact with a cam radii of the set of cam shafts as the optical lens is moved between an in focus axial position and an out of focus position. The system may further comprise a controller (not shown) that synchronizes the motors. Additionally, the assembly may comprise a set of sensors that obtain information from which the axial displacement of optical element 1205 can be determined. The sensor data can be used by a controller to generate a synchronizer signal that is provided to an ROIC for use in synchronizing the demodulation phase of processing the modulated image signal.

The cam-based approach can generate a more efficient, square-wave modulation waveform. However, this comes with the tradeoff that the maximum practical modulation frequency is lower than a system such as optical lens system 800 of FIGS. 8A and 8B. Modulation frequencies in the 10-40 Hz range have been achieved using the cam, but the cam and optical element assembly technique for manipulating the PSF becomes impractical above that rate. The cam approach could be useful for applications where maximizing the total signal is more important than fast modulation rates. In some embodiments, a cam system provides fine control over PSF, which would enable fine tuning of effective DoG filtering by the system (e.g., a fine tuning of a spatial high pass filter).

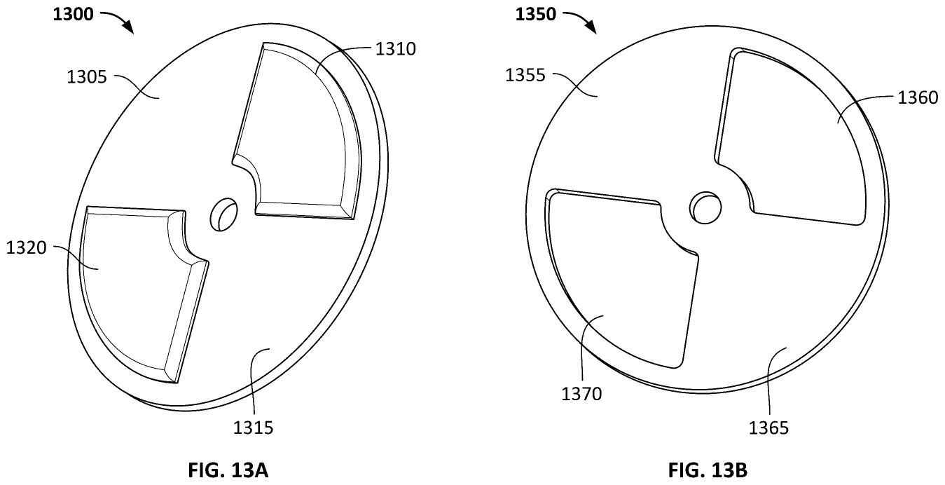

According to various embodiments, the system is configured to manipulate the PSF by modulating the optical path length. For example, the system sequentially changes the optical path length along which input optical signal travels. In some embodiments, the system changes the optical path length by implementing one or more of (i) changing a medium through which incident input optical signals travel, (ii) sequentially blocking and unblocking the path along which the input optical signal travels (e.g., to sequentially permit the input optical signal to reach the detector), and/or (iii) changing a physical length along which the input optical signal travels to reach the detector. FIG. 13A illustrates an example of a phase delay wheel for an optical lens system according to various embodiments. A phase delay wheel can be used as a technique for manipulating the path length to an imaging device. FIG. 13B illustrates an example of a chopper wheel for an optical lens system according to various embodiments. A chopper wheel can be used as a technique for blocking and unblocking the path length to an imaging device.

The examples illustrated in FIGS. 8A and 8B and 11 and 12 implement modulation by introducing a transition in the focus of the optical system. In those examples, this is accomplished by moving an optical element (e.g., relative to the detector or focal plane array used to capture the image signal) to change the ideal focus position of a system. An alternative approach takes into account the fact that optical path delay is the product of not only physical distance, but also the index of refraction of the medium. For example, if a section of back focal distance is changed from air/vacuum to a higher index material, then the ideal focus position will change.

The magnitude of this change can be shown to be given by the thickness of the introduced higher index material times (1-1/n), where n is the index of the introduced medium. This reduces the issue of modulation to an issue of rapidly introducing and removing such a phase delay plate. To accomplish this, a device analogous to a chopper wheel could be introduced, but instead of an opaque medium that blocks the light, this system would introduce a substantial phase delay synchronously with the “down” count phase of the modulation cycle.

The advantage of this technique is that it allows for a scene average intensity in the down count phase that should be equivalent to the scene average intensity while up-counting. The physical implementation of this device would a mechanical ring of an optically transparent material with multiple wedge section which are either azimuthally different in thickness to produce the desired phase delay or cut out such that there is no material in that segment of wedge.

In the example shown in FIG. 13A, phase delay wheel 1300 comprises different elements that sequentially change the optical path of the input optical signal. For example, phase delay wheel 1300 comprises first element 1305, second element 1310, third element 1315, and fourth element 1320. As the phase delay wheel 1300 is rotated in the optical path of the input optical signal, the optical path sequentially travels through first element 1305, second element 1310, third element 1315, or fourth element 1320. First element 1305 and third element 1315 may have the same optical path properties, and second element 1310 and fourth element 1320 may have the same optical path properties. For example, first element 1305 and third element 1315 comprise a material having a same physical thickness and composed of the same index material. In the example shown, first element 1305 and second element 1310 may have different indices or physical thicknesses.

In the example shown in FIG. 13B, phase delay wheel 1350 comprises different elements that sequentially change the optical path of the input optical signal. For example, phase delay wheel 1350 comprises first element 1355, second element 1360, third element 1365, and fourth element 1370. As the phase delay wheel 1350 is rotated in the optical path of the input optical signal, the optical path sequentially travels through first element 1355, second element 1360, third element 1365, or fourth element 1370. In some embodiments, phase delay wheel 1350 is composed of a particular material having a particular refractive index and second element 1360 and fourth element 1370 correspond to cut-outs from this material to cause the optical path through second element 1360 and fourth element 1370 to be air. Accordingly, as the phase delay wheel 1350 is rotated, the optical path for the input optical signal is sequentially: (i) through the particular material, and (ii) through a cut-out from the particular material.

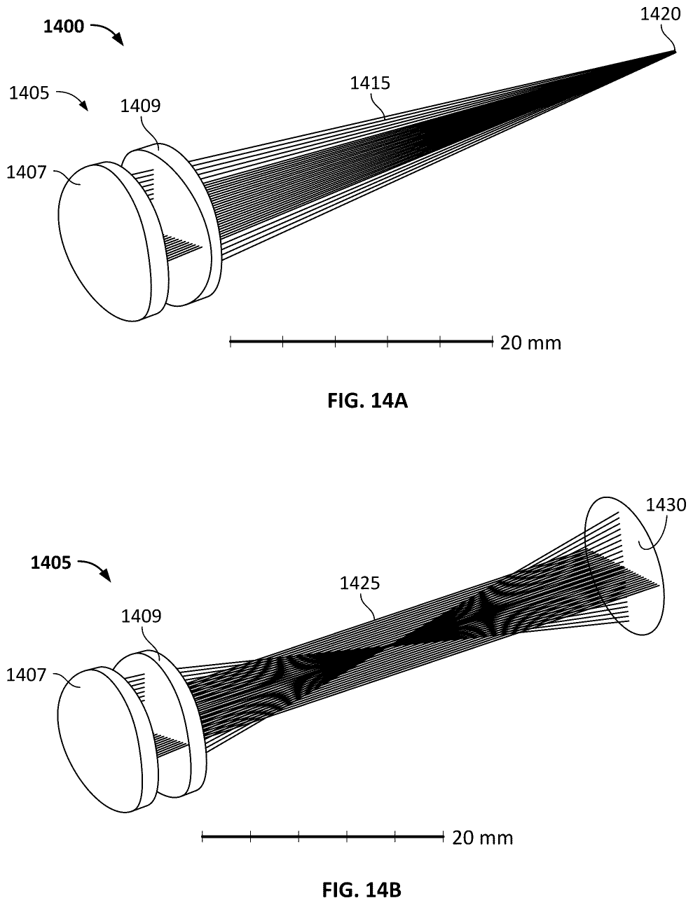

Various embodiments implement a lens assembly comprising a set of lenses that the system configures to sequentially transition between aligned and non-aligned to cause the manipulation of the PSF in connection with modulation of the input optical signal. FIGS. 14A and 14B illustrate examples of using a set of lenses in an optical lens system to module an input optical signal system according to various embodiments.

Optical power in lenses is traditionally radially symmetric, such as symmetric around the optical axis. However, some types of lenses separate optical power into orthogonal components. These types of lenses are generally referred to as cylindrical, acylindrical, toroidal, or atoroidal lenses depending on the exact profile of the curvature on the surface. When two of such lenses are oriented with their powered axes orthogonally rotated there will be equivalent curvature in X and Y, which results in a symmetric focus.

However, if the orientation of these lenses (e.g., cylinder lenses) is then oriented such that both lenses put optical power into the same axis, the resultant beam is given a substantial degree of astigmatism. The ideal focus becomes a line due to the imbalance of optical power, and at the original focus plan the spot is highly expanded.

According to various embodiments, the system causes a set of lenses to rotate relatively to one another. The relative rotation of the set of lenses causes the lenses to transition between an aligned configuration and a non-aligned configuration. For example, the system causes a high-speed relative rotation of the set of lenses, cylinder lenses such that the optics are repeatedly in the orthogonal well-focused position to create tightly focused spots. When this set of lenses (e.g., these two cylindrical optics) are rotated out of this ideal position (e.g., to a non-aligned configuration) the produced spot is defocused. The defocusing of the produced spot may be proportional to the degree of rotation and the degree of curvature of the lenses. Either or both lenses in the set of lenses (e.g., in the case that the set of lenses comprises two lenses) may spin, and such spinning may be continuous or partial, depending on the degree of desired defocus and the rate of desired demodulation.

In some embodiments, the system is configured to up-count the signal obtained from the detector, optics package, and/or amplifier while the lenses are substantially orthogonally clocked (e.g., when the set of lenses are set to an aligned configuration). The system is configured to down-count the output from the optics package and/or amplifier (e.g., when the output from the detector is not counted) when the lenses are not orthogonally clocked (e.g., when the set of lenses are set to a non-aligned configuration).

In the example shown, system 1400 comprises lens assembly comprising a set of lenses 1405. The set of lenses 1405 comprise at least a first lens 1407 and a second lens 1409. System 1400 is configured to direct the optical path through which the input optical signal travels to be incident on a detector (e.g., a focal plane array). System 1400 controls configuration of the set of lenses 1405 to sequentially modify relative alignment of the first lens 1407 and the second lens 1409. As illustrated in FIG. 14A, the set of lenses 1405 is controlled to configure the first lens 1407 and the second lens 1409 to be aligned (e.g., orthogonally clocked) and create a resulting beam 1415 (e.g., the modulated input optical signal) to be focused on spot 1420. As illustrated in FIG. 14B, the set of lenses 1405 is controlled to configure the first lens 1407 and the second lens 1409 to be non-aligned (e.g. not orthogonally clocked) and create resulting beam 1425 to be de-focused as spot 1430.

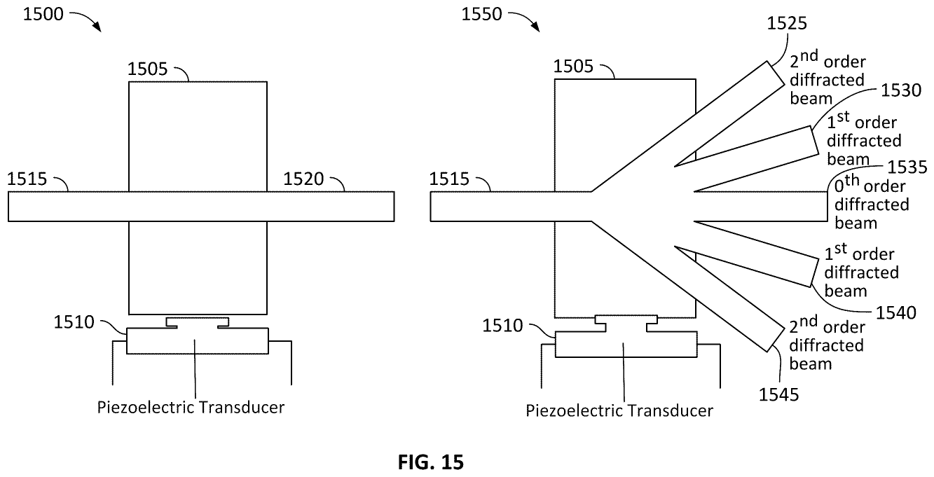

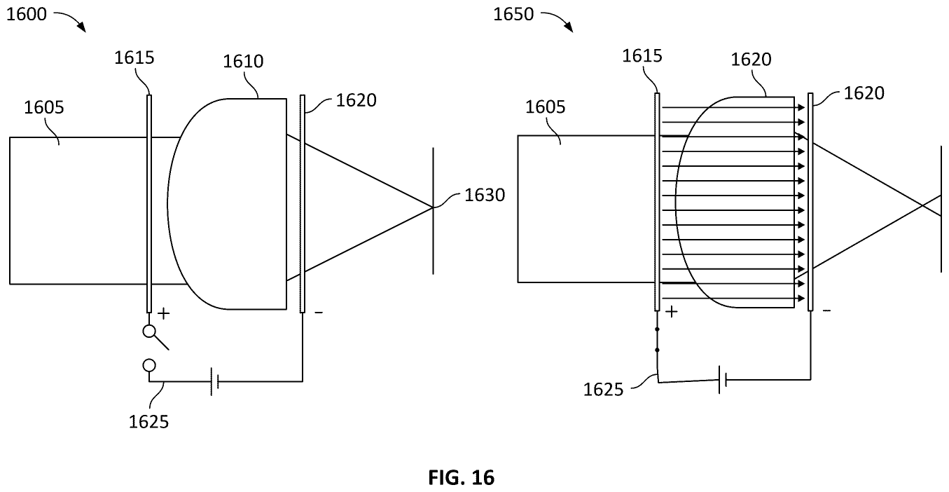

According to various embodiments, another technique for manipulating the PSF in connection with modulating an input optical signal includes controlling an acousto-optical modulator to change an optical path. FIG. 15 illustrates an acousto-optical modulator for modulating an input optical signal according to various embodiments.

An acousto-optical modulator is a component in fiber optic and laser optic devices. The system may comprise a controller that controls the acousto-optical modulator to modulate the optical path. In some embodiments, the acousto-optical modulator is comprised of a mechanical transducer which inputs force into an optical medium (e.g., crystalline). The force input by the mechanical transducer is modulated by the controller at a set frequency (e.g., the modulation frequency) to create an effective standing sound wave propagating across the medium. When an optical medium is compressed, its index of refraction slightly changes proportionally to the effective increase in material density. These gradients of the index of refraction can induce Bragg diffraction, a phenomenon where light is changed in angle due to interference effects. As an example, this effect is proportional to wavelength and spacing of the index bands. For a non-monochromatic beam, the light creates a continuum of angles of diffraction proportional in width to spectral bandwidth of the input, which will appear to a detector as a broad spot. For example, the light will no longer be well focused at its original position. Accordingly, the system controls the mechanical transducer to effectively focus and defocus the input optical signal on the detector (e.g., a focal plane array). The detector can thus detect the input optical signal as a modulated optical signal based on sequential focusing and defocusing of the spot on the focal plane array according to the modulation frequency.

According to various embodiments, the system is configured to up-count the signal (e.g., obtained from the detector, optics package, and/or amplifier) when the mechanical transducer (e.g., the piezoelectric modulator) is off. Conversely, the system is configured to down-count when the mechanical transducer (e.g., the piezoelectric modulator) is turned on. This technique of using an acousto-optical modulator for modulating an input optical signal is effective because the system is configured to disrupt the beam quality and thus there is not a strong need to have perfect efficiency, specific and predictable beam angle steering, or a continuous/stable steady-state standing wave.

In the example shown, the system comprises optical medium 1505 through which input optical signal 1515 is transmitted. The system further comprises a mechanical transducer 1510 that is configured to apply a force on medium 1505 according to a controlled modulation. As an example, the mechanical transducer 1510 is a piezoelectric transducer. In configuration 1500, mechanical transducer 1510 is turned off (e.g., not driven) and thus does not cause a mechanical stress to be applied to medium 1505. When the system is in configuration 1500, the input optical signal 1515 passes through medium 1505 to be beam 1520 that is focused on a detector. In contrast, according to configuration 1550, the system turns on the mechanical transducer 1510 (e.g., the system drives the piezoelectric transducer) which causes mechanical stress to be applied to medium 1505. In response to mechanical transducer 1510 being driven and thereby applying the mechanical stress on medium 1505, medium 1505 is configured to diffract input optical signal 1515 which causes the resulting beam to be defocused on the detector. For example, as input optical signal 1515 is transmitted through medium 1505 when mechanical transducer 1510 is being driven, the beam is diffracted and causes a resulting beam comprising a set of diffracted beams. For example, the resulting beam comprises a 0^{th} order diffracted beam 1535, 1^{st} order diffracted beams 1530 and 1540, 2^{nd} order diffracted beams 1525, 1545, etc.

In some embodiments, wherein manipulating the effective PSF or boresight orientation of the optical system comprises driving an acousto-optical modulator to modify an index of refraction of a medium through which the optical input signal propagates, wherein the index of refraction is modified at a predefined frequency or set of frequencies. In some embodiments, the acousto-optical modulator does not modulate a PSF directly, but is an “effective PSF manipulation” via dithering the pointing rapidly of a beam propagating through the acousto-optic modulator. In some embodiments, this effective PSF manipulation is achieved by driving an acousto-optical modulator with a set of frequencies (i.e., a chirp).

The system thus detects (at detector) the modulated optical signal based on the focused resulting beam and de-focused resulting beam transmitted through medium 1505. The system obtains the modulated image signal, and the system processes the modulated image signal to perform demodulation according to the modulation frequency.

According to various embodiments, another technique for manipulating the PSF in connection with modulating an input optical signal includes controlling an electro-optical modulator to change an optical path, similar to the technique described above using an acousto-optical modulator. FIG. 16 illustrates an electro-optical modulator for modulating an input optical signal according to various embodiments.

In some embodiments, the system uses electro-optical modulation to modify the index of refraction of a substrate material having non-linear optical properties through which the input optical signal travels. The medium through which the input optical signal is transmitted may comprise a material such as lithium niobate or gallium arsenide. Various other materials having non-linear optical properties can be implemented.

In some embodiments, the system controls the electro-optical modulation to actuate the medium in a manner that causes the medium to introduce a phase shift in the transmitted light. The phase shift may be proportional to π/2 phase, such that in concert with polarizing filters the light could be selectively allowed to pass through or become extinguished.

In some embodiments, the index of an optical element is modified (e.g., directly) to introduce a substantial focus delay. An optical element is placed in between conductive electrodes. The conductive electrodes may be disposed at a distance from the optical element or directly adhered to the surface of the optical element. According to various embodiments, the system is configured to up-count the signal (e.g., obtained from the detector, optics package, and/or amplifier) when no voltage is applied to the electrodes and the optical element (e.g., the medium through which the input optical signal travels) permits the optical signal to be transmitted to form a focused spot on the detector. Conversely, the system is configured to down-count when voltage is applied to the electrodes and the optical element causes the light to form a defocused spot on the detector. The application of the voltage applied across the electrodes causes the effective index of refraction of the lens to change, thereby changing the focus location. As such, the resulting beam forms a defocused spot. Accordingly, the system uses a detector to capture the resulting beam which is modulated between a focused spot and a defocused spot according to control of the voltage applied across the electrodes.

In the example shown, the system comprises optical medium 1610 through which input optical signal 1605 is transmitted. The system further comprises a set of electrodes 1615 and 1620 disposed on opposing sides of optical medium 1610. The system comprises an electric circuit 1625 that is controlled to sequentially turn on and turn off a voltage across electrodes 1615 and 1620. The voltage across the electrodes 1615 and 1620 is configured to apply an electric field across medium 1610 to change an index of refraction according to a controlled modulation. In configuration 1600, circuit 1625 is controlled to turn off voltage across electrodes 1615 and 1620, and thus the electrodes do not cause an electric field to be applied to medium 1610. When the system is in configuration 1600, the input optical signal 1605 passes through medium 1610 to be a resulting beam focused at focus spot 1630 on a detector. In contrast, according to configuration 1650, the system controls electric circuit 1625 to apply a predefined voltage across the set of electrodes 1615 and 1620 (e.g., the system drives the electric circuit) which causes a change to the index of refraction of medium 1610. In response to electric circuit 1625 being driven and thereby applying the electric field on medium 1610, medium 1610 is configured to change focal length of medium 1610 which causes the resulting beam to be defocused on the detector.

The foregoing examples describe techniques for modulating an input optical signal based on a manipulation of the PSF. However, various other techniques may be used to modulate the input optical signal. An example of such a modulation technique is the modulation of the intensity of the light incident on the detector (e.g., the optical input signal is modulated based on a modification of the light intensity).

According to various embodiments, intensity modulation is performed by physically blocking and unblocking the input optical signal at a high rate and alternating ROIC counter polarity synchronously. The system integrates (e.g., up-counts) the focal plane photo-current (e.g., the result obtained by the detector) with the unblocked image and down-counts when the system is configured to block the light incident on the detector. The system removes higher contrast scene imagery from the demodulation image, allowing the direct removal of excess focal plane noise.

An example of a system implementing intensity modulation is a system that controls a mechanical chopping of the input optical system incident on the detector. FIG. 17 illustrates a chopper for modulating an input optical signal according to various embodiments. In some embodiments, the system may implement chopper 1700 in the optical path of the input optical signal towards the detector. The system controls chopper 1700 to mechanically chop the input optical signal. In some embodiments, demodulates the modulated image signal synchronously with the modulation of the input optical signal (e.g., the modulation of the chopper) in order to reduce the noise in the modulated image signal. According to various embodiments, the system implements a linear or rotary mechanical chopper that is placed in the optical path. In the example shown, chopper 1700 is a linear chopper that the system controls to linearly shift apertures and blocking sections of chopper 1700 across the optical path of the input optical signal to successively permit and block, respectively, transmission of the input optical signal to the detector.

According to various embodiments, successive “open” and “blocked” sections of the chopper are rapidly scanned through the beam (e.g., the input optical signal) to generate a modulated optical signal. The “blocked” sections cut off the scene signal and provide a flat-field input into the focal plane. Synchronously, the focal plane array sensor swaps polarity to add counts on the unblocked section and subtract them on the blocked section. The resultant derived image experiences a reduction of noise.

In some embodiments, the system has demonstrated shot noise limited performance for both temporal and spatial noise.

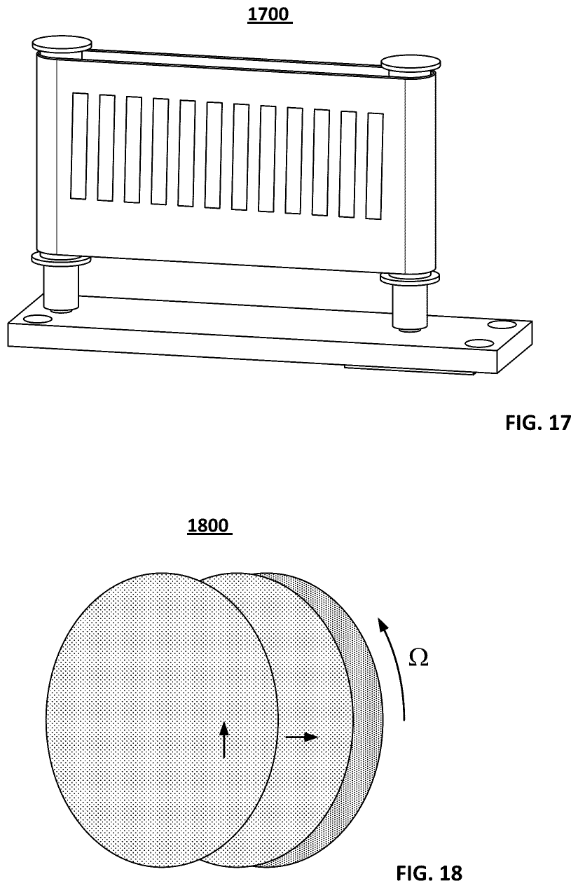

Another technique for implementing intensity modulation is to successively cause a medium in the optical path of the input optical signal incident on the detector to be polarized or unpolarized. FIG. 18 illustrates a cross-polarized system for modulating an input optical signal according to various embodiments. In some embodiments, the system modulates the input optical signal by modulating a set of polarizers, such as an optical assembly comprising a set of polarized elements. The system configures the polarizing elements to be dynamically positioned relative to each other to successively permit or block transmission of the input optical signal to the detector. For example, the polarizing elements are dynamically configured to alternate between aligning the polarized fields transmitted through the set of polarizing elements, and introducing a cross-polarizing scenario where the input optical signal (e.g., all of the signal) is blocked from reaching the focal plane (e.g., the detector). The use of polarizing elements to successively permit or block transmission of the input optical signal to modulate the signal may cause a baseline signal reduction, because as all transmitted light, even in the “unblocked” time periods, must be polarized, reducing signal level on a generic unpolarized scene by approximately ½.

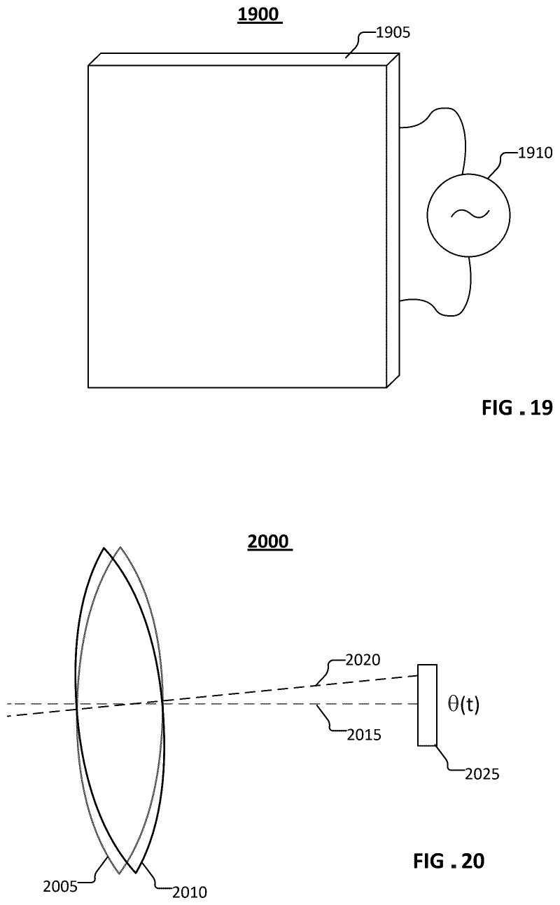

Another technique for implementing intensity modulation is to successively cause a change in an index of refraction of a medium through which the input optical signal travels to reach the detector. FIG. 19 illustrates an electro-optical modulator for modulating an input optical signal according to various embodiments. In some embodiments, the system modulates the input optical signal by modulating the light intensity using electro-optical modulator.

In some embodiments, the system implements an electro-optical modulator comprising optical materials with an inherent electro-optical effect. The application of an electric field across the optical materials impacts the index of refraction of the material, which can be used to modulate the light intensity of light permitted to pass through the material. The system modulates the applied electric field thereby causing a phase modification in the transmitted light. In some embodiments, the system combines the electo-optical modulator with a polarizer having appropriate alignment, and thus modulates the electric field to vary transmitted light amplitude by varying the phase from aligned to orthogonal for the polarizer.

In the example shown, the system implements electro-optical modulator 1900 comprising an optical element 1905 and electric circuit 1910. Optical element 1905 is a medium through which input optical signals are transmitted, and the medium comprises an optical material having a property that an electric field causes a change in its index of refraction. The system modulates the electric field applied to optical element 1905 by controlling electric circuit 1910.

According to various embodiments, the input optical signal can be modulated based on a motion scanning. Modulation by motion scanning works by physically altering the line of sight of the imaging system at the modulation frequency so as to either spoil the image or to otherwise move the image to a different spot on the focal plane array during periods of ROIC down-counting.

FIG. 20 illustrates a system for modulating an input optical signal based on dithering a line of sight of an optical lens system according to various embodiments. In the example shown, the system comprises an optical system 2000 comprising a lens. The system causes the orientation of the lens to dither, such as between lens orientation 2005 and lens orientation 2010. Dithering the lens causes the resulting beam to dither thereby changing a location to which the scene is transmitted to detector 2025. For example, when the lens is oriented in lens orientation 2005, the lens focuses resulting beam as beam 2015. Conversely, when the lens is oriented in lens orientation 2010, the lens focuses the resulting beam as beam 2020.

Imaging systems are often designed with line-of-sight stabilization mechanisms to reduce or eliminate jitter induced blurring while operating in a vibration environment. Stabilization mechanisms can include gimbals or mechanisms for manipulating elements such as lenses, Risley prisms, or other elements to change the line-of-sight of the imaging system. Typically, the stabilization system would close the loop around a gyroscope or inertial measurement unit (IMU), which measures heading changes.

Although the typical goal of such mechanisms is to minimize vibration induced blur, such mechanisms can be controlled to induce blur by causing the system to dither. As illustrated in FIG. 20, the lens element is manipulated to change line-of-sight angle.

In this implementation of modulation, the system (e.g., the ROIC) down-counts when the stabilization system is dithering, and thus spoiling the image. Conversely, the system up-counts when the stabilization system is not dithering, and thus is in-focus.

According to various embodiments, the system implements a dither modulation. If a stabilization mechanism (e.g., gimbal, lens manipulation, Risley prism, etc.) has sufficient bandwidth to rapidly settle at a new line-of-site angle setpoint, a dither modulation can be implemented. This is very similar to the previous example, except that, instead of spoiling the image during the ROIC down count cycle, the line-of-sight is moved over by a predefined number of pixels. The use of a bimodal dither modulation can generate an image with a “salt-and-pepper” look to it. For example, such an implementation will create a superimposed pair of images where one of the images is offset from the original by a predefined number of pixels as well as inverted. In various embodiments, the dither comprises a bimodal, a continuous, a trimodal, or any other appropriate dither that is taken into account in demodulation.

Although the superimposed pair of images may not seem natural to look at by the human eye, a matched filter can be designed to detect the characteristic “salt-and-pepper” signature and identify targets in a scene. This technique is particularly effective in applications where imagery is not the end-goal of a system, but rather systems that are used to perform detections, such as in an airborne infrared search and track (IRST) system.

Due to the fast-settling time required, this technique can be more technically challenging to achieve compared to others, particularly at high modulation frequencies. However, this technique comes with the benefit of an up to 2× increase in useful signal due to the matched filter gain while still eliminating excess noise.

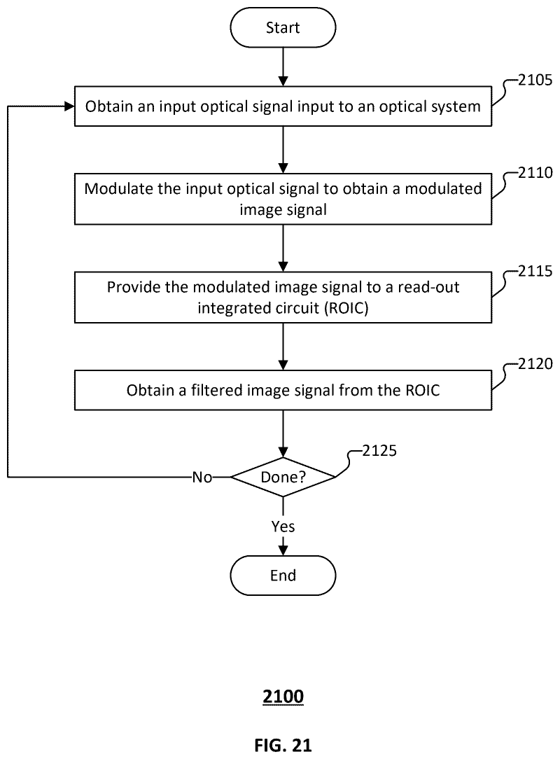

FIG. 21 is a flow diagram of a method for filtering noise from an input optical signal according to various embodiments. In some embodiments, the system removes excess noise from a detected image signal based at least in part on modulating an input optical signal and demodulating an image signal based on a scene captured by a detector.

At 2105, the system obtains an input optical input to an optical system. For example, the system causes the input optical system to be incident on an optical system, such as a lens assembly or other medium through which the input optical signal is to pass before reaching a detector. The input optical signal may be an infrared signal.

At 21010, the input optical signal is modulated to obtain a modulated image signal. In some embodiments, the input optical signal is modulated based at least in part on manipulating a point spread function (PSF) of the optical system.

At 2115, the modulated image signal is provided to a read-out integrated circuit (ROIC). The ROIC can process the modulated image signal to obtain a filtered image signal which corresponds to the image signal of the scene with excess noise removed. The ROIC may comprise a demodulator that is configured to demodulate the modulated image signal, such as according to the modulation frequency with which the input optical signal is modulated.

At 2120, the system obtains a filtered image signal from the ROIC. The system demodulates the modulated image signal and filters the demodulated image signal to remove the contributions of excess noise.

At 2125, a determination is made as to whether process 2100 is complete. In some embodiments, process 2100 is determined to be complete in response to a determination that no further image signal is to be collected, an administrator indicates that process 2100 is to be paused or stopped, etc. In response to a determination that process 2100 is complete, process 2100 ends. In response to a determination that process 2100 is not complete, process 2100 returns to 2105.

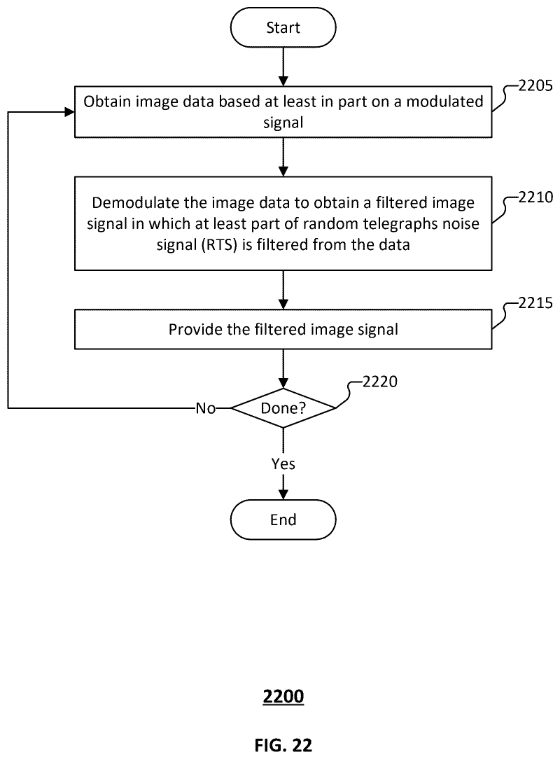

FIG. 22 is a flow diagram of a method for filtering noise from an input optical signal according to various embodiments. In some embodiments, the system processes a modulated image signal in connection with removing excess noise from a detected image signal based at least in part on modulating an input optical signal and demodulating an image signal based on a scene captured by a detector.

At 2205, the system obtains image data based at least in part on a modulated signal, such as a modulated image signal. For example, the system collects image data from a detector that detects a modulated image signal and processes the modulated image signal using an amplifier. The detector and/or the amplifier may introduce RTS noise.

At 2210, the system demodulates the image data to obtain a filtered image signal. In some embodiments, the filtered image signal corresponds to a signal for the scene captured by the optical system in which at least part of a RTS noise signal is filtered out. In some embodiments, the system demodulates the image signal according to the same frequency with which the input optical signal is modulated to obtain the modulated signal. After demodulation, the system can filter the excess noise to return image data corresponding to the scene being captured by the system with the excess noise removed.

At 2215, the system provides the filtered image signal. For example, the system provides the filtered image signal to another system or module that performs image detection, such as to detect objects in the captured scene.

At 2220, a determination is made as to whether process 2200 is complete. In some embodiments, process 2200 is determined to be complete in response to a determination that no further image signal is to be processed or have excess noise removed therefrom, an administrator indicates that process 2200 is to be paused or stopped, etc. In response to a determination that process 2200 is complete, process 2200 ends. In response to a determination that process 2200 is not complete, process 2200 returns to 2205.

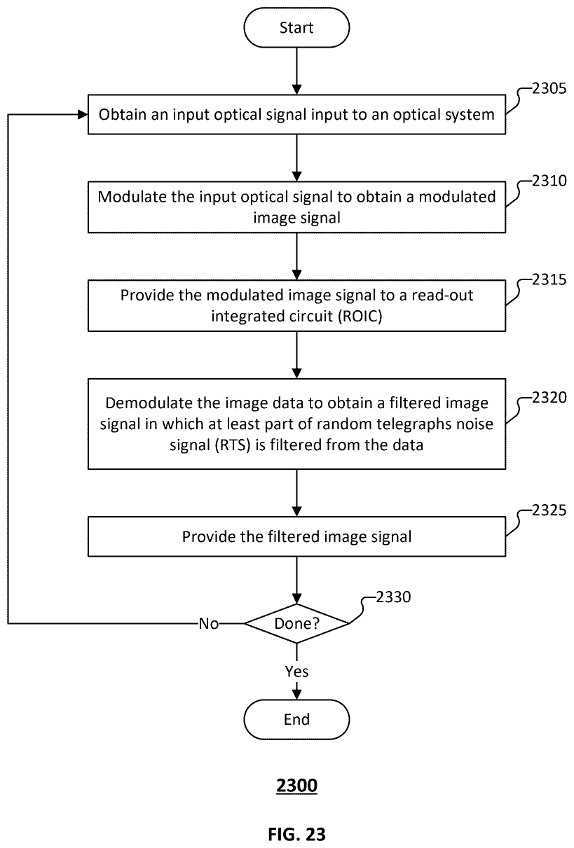

FIG. 23 is a flow diagram of a method for filtering noise from an input optical signal according to various embodiments. At 2305, the system obtains an input optical signal input to an optical system. At 2310, the system modulates the input optical signal to obtain a modulated image signal. In some embodiments, the system modulates the input optical signal based on one or more of manipulation of the PSF, manipulation of the light/signal intensity, manipulation of the line-of-sight. The modulated image signal is captured by a detector such as a focal plane array. At 2315, the system provides modulated image signal to a read-out integrated ROIC circuit. At 2320, the system demodulates the image data to obtain a filtered image signal in which at least part of the RTS noise is filtered from the data. At 2325, the system provides the filtered image signal. At 2330, a determination is made as to whether process 2300 is complete. In some embodiments, process 2300 is determined to be complete in response to a determination that no further image signal is to be processed or have excess noise removed therefrom, an administrator indicates that process 2300 is to be paused or stopped, etc. In response to a determination that process 2300 is complete, process 2300 ends. In response to a determination that process 2300 is not complete, process 2300 returns to 2305.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for filtering noise from image data, comprising:
obtaining an input optical signal input to an optical system;
modulating the input optical signal to obtain a modulated image signal, wherein the input optical signal is modulated based at least in part on manipulating a point spread function (PSF) of the optical system;
providing the modulated image signal to a read-out integrated circuit (ROIC); and
obtaining a filtered image signal from the ROIC, wherein the ROIC filters the modulated image signal to remove at least part of excess noise in image signal data.

2. The method of claim 1, wherein the input optical signal is an infrared signal.

3. The method of claim 1, wherein the excess noise is removed from the image signal data in real time.

4. The method of claim 1, wherein a predefined frequency of the modulated image signal is higher than an excess noise knee frequency.

5. The method of claim 1, wherein modulating the input optical signal includes up-converting an image signal to a modulated frequency to obtain the modulated image signal.

6. The method of claim 1, wherein manipulating the PSF of the optical system comprises:
causing an optical lens that directs the input optical signal to a focal plane to move between in focus and out of focus at a predefined frequency.

7. The method of claim 6, wherein the optical lens is mounted to a bezel by a set of flexures, and wherein causing the optical lens to move between in focus and out of focus comprises causing the optical lens to move axially according to the predefined frequency by actuating a plurality of voice coils.

8. The method of claim 1, wherein manipulating the PSF of the optical system comprises:
controlling at least one motor to drive one or more cam shafts,
wherein:
a first cam shaft in the set of cam shafts has a variable radii; and
rotation of the cam shaft causes an optical lens to move between in focus and out of focus at the predefined frequency.

9. The method of claim 8, wherein an axial position of the optical lens follows a cam radii for the set of cam shafts as the set of cam shafts are rotated.

10. The method of claim 8, wherein the optical lens is mounted to a bezel by a set of flexures, and the bezel is preloaded with a spring to keep the optical lens motion in contact with a cam radii of the set of cam shafts as the optical lens is moved between an in focus axial position and an out of focus position.

11. The method of claim 1, wherein manipulating the PSF of the optical system comprises:
controlling a set of non-spherical lenses to move between an aligned position and a non-aligned position at the predefined frequency.

12. The method of claim 11, wherein the controlling a set of non-spherical lenses to move between the aligned position and the non-aligned position comprises:
causing a first lens and a second lens to relatively rotate with respect to each other at a predefined frequency.

13. The method of claim 1, wherein manipulating the PSF of the optical system comprises:
driving an electro-optical modulator to modify an index of refraction of a medium through which the input optical signal propagates, wherein the index of refraction is modified a predefined frequency.

14. The method of claim 1, wherein manipulating the PSF of the optical system comprises:
modifying an index of refraction of an input optical signal path,
the index of refraction of the input optical signal path is modified based on rotating a phase delay wheel configured in the input optical signal path to permit the input optical signal to pass therethrough,
wherein:
the phase delay wheel being rotated at a predefined frequency; and
the phase delay wheel has a plurality of different portions comprising one or more of (i) different indices of refraction and (ii) different physical thicknesses.

15. The method of claim 1, wherein the modulated image signal is demodulated to obtain the filtered image signal.

16. An optical system, comprising:
an optical component configured to obtain an input optical signal;
a component configured to cause the input optical signal to be modulated to obtain a modulated image signal, wherein the input optical signal is modulated based at least in part on manipulating a point spread function (PSF) of the optical system;
a read-out integrated circuit (ROIC) configured to process a modulated input optical signal;
a processor configured to obtain a filtered image signal from the ROIC, wherein the ROIC filters the modulated image signal to remove at least part of excess noise in the image signal data; and
a memory coupled to the processor and configured to provide the processor with instructions.
